(19) United States
(12) Patent Application Publication
(10) Pub. No.: US 2007/0235496 A1
(43) Pub. Date: Oct. 11, 2007

(54) Multi-orifice collet for a pick-and-place machine

(76) Inventors: Sundar A/L Natarajan Yoganandan, Penang (MY); Thye Linn Mok, Penang (MY)

Correspondence Address: Kathy Manke;Avago Technologies Limited, 4380 Ziegler Road, Fort Collins, CO, 80525, US

(21) Appl. No.: 11/399,812

(22) Filed: Apr. 7, 2006

(51) Int. Cl. B23K 5/00; B23K 1/00

(52) U.S. Cl. 228/6.1; 228/6.2

(57) ABSTRACT

The invention relates to a system and method for simultaneously transferring multiple components using multi-orifice collets with a pick-and-place apparatus. Multiple electronic components, such as light emitting diodes can be picked and place simultaneously while maintaining the spacing and orientation of the components found in the original location.

### CROSS-REFERENCE TO RELATED APPLICATIONS

Not applicable.

### TECHNICAL FIELD

The present invention relates to and apparatus and method for the placement of electronic components, and more specifically to a collet or probe used in pneumatic pick-and-place equipment to place components such as light-emitting diode (LED) chips.

### BACKGROUND OF THE INVENTION

The placement and arrangement of electronic components, such as semiconductor chips, is often accomplished using pick-and-place equipment. This equipment is used to transfer a chip from one location, usually a fabrication point, to a second location such as a circuit board or the like. For many components, such as LED chips, the pick-and-place equipment is often pneumatic, using suction to lift the chip off its original substrate and transfer the chip to another location.

Typical collets comprise a collet body with a single orifice at the face of the collet. The orifice is pneumatically connected to a central channel, which, in turn, is pneumatically connected to a vacuum pump or similar device. When the pump is activated, a vacuum is created, which lifts the chip up until it contacts the collet. By movement of the arm of the pick-and-place machine, the chip is the transferred to the desired location. Once the chip is in place, the vacuum pump is turned off and the chip falls into place. In current solutions, however, each collet lifts only one chip at a time. To move multiple chips, either the apparatus must repeat the process of lifting and moving the chip several times, or multiple collets are used. This can often make it difficult to achieve an acceptable chip separation without significant reduction in production rates.

This is particularly important in the case where multiple components need to be placed in close proximity to each other. For example, in order to ensure that light emitted by one LED chip blends with the light from a neighboring chip, the pick-and-place equipment must often pick-and-place each individual chip multiple times until the desired pattern is achieved.

Problems, therefore, are encountered with present pick-and-place technology spacing the individual chips without significant variation. With typical current solutions, spacing between chips of about 2 mils is the minimum that can be achieved while maintaining acceptable production rates. While smaller tolerances can be achieved, this requires slowing the pick-and-place equipment, thereby reducing production rates. Additional variations in placement are also introduced by the movement of the pick-and-place equipment and such other steps, such as the tape transfer processes.

### BRIEF SUMMARY OF THE INVENTION

The present invention is directed to a system and method which use a pneumatic pick-and-place machine capable of moving multiple objects simultaneously. A collet with multiple orifices permits the embodiment to pick up at least two components simultaneously while maintaining the distance and orientation of those components The example collet comprises a central channel pneumatically connected to each orifice through a path of intermediate channels. The orifices of embodiment collets can be arranged to provide the necessary spacing and placement patterns appropriate for the objects being placed.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a cross section of an embodiment collet of the present invention;

FIG. 2 is a cross section of an alternative embodiment of a collet of the present invention;

FIG. 3 is a face of an example collet in one embodiment of the invention.

FIG. 4 is an alternative face of an example collet in one embodiment of the invention.

FIG. 5 is a depiction of an example method transferring cut chips using an embodiment of the invention.

FIG. 6 is a side view of an example method of transferring components using an embodiment of the present invention.

### DETAILED DESCRIPTION OF THE INVENTION

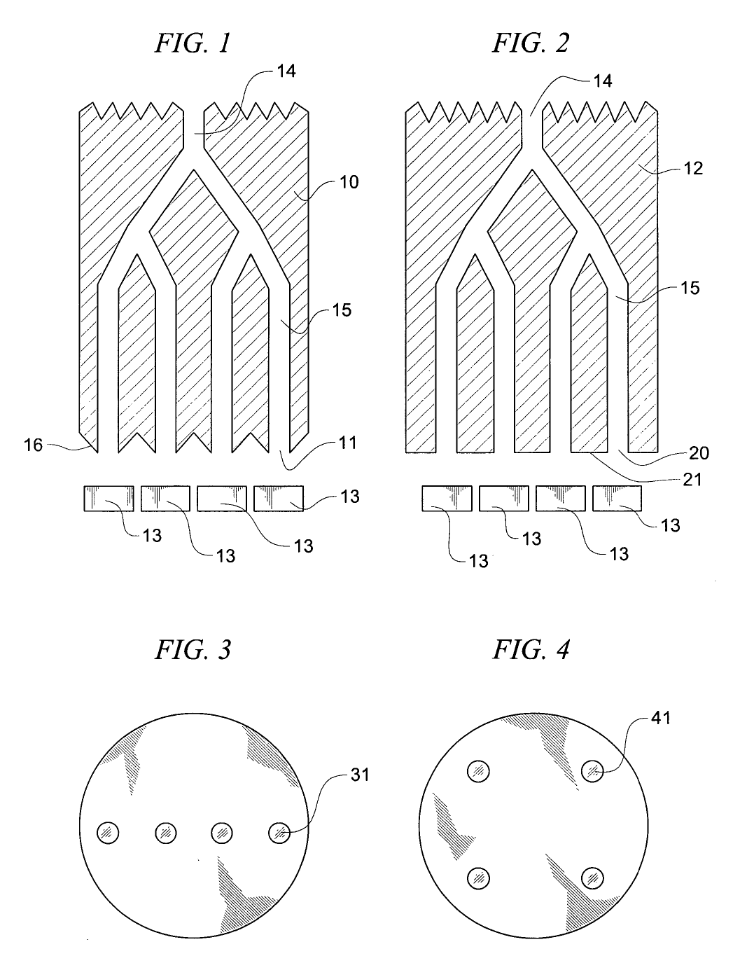

FIG. 1 depicts an example collet arranged according to one embodiment of the present invention. Collet 10 is shown with multiple orifices 11 in its face which permits collet 10 to address multiple chips 13 simultaneously. Orifices 11 are pneumatically connected to central channel 14 within the body of collet 10 by intermediate channels 15. Collet 10 may be attached to an arm of a pick-and-place apparatus (not shown) which is capable of moving the collet both vertically and horizontally so that components can be moved.

In the embodiment shown in FIG. 1, tapered tips 16 extend out from the face of collet 10 forming individual orifices 11. FIG. 2 depicts an alternative embodiment in which orifices 20 are formed from squared tips 21. An arrangement such as FIG. 2 allows orifices 20 to be flush with the surface of chips 13.

When a vacuum is applied to either collet 10 or 12, the vacuum is transferred to the orifices allowing 2 or more chips 13 to be lifted simultaneously, while also automatically providing the appropriate separation between chips 13. In many embodiments, this spacing can be less than 2 mils (approximately 50.0 microns) depending upon the method used to dice the original wafer. While the vacuum is applied to the collet, chips 13 remain in contact with its face, and attached pick-and-place machine may maneuver chips 13 to their desired location. Once chips 13 are in place, the vacuum is released and chips 13 separate from the face of the collet.

The orifices of collets in embodiments of the present invention can be arranged in a number of different patterns. For example, FIG. 3 depicts orifices 31 arranged in a linear pattern, and FIG. 4 depicts orifices 41 arranged in a square. The number and arrangement of the orifices will depend upon the desired use for the components, the physical capacity of the collet, and other factors specific to the system. It will be apparent to those of ordinary skill in the art that the present invention is not limited to any specific number or arrangements of orifices.

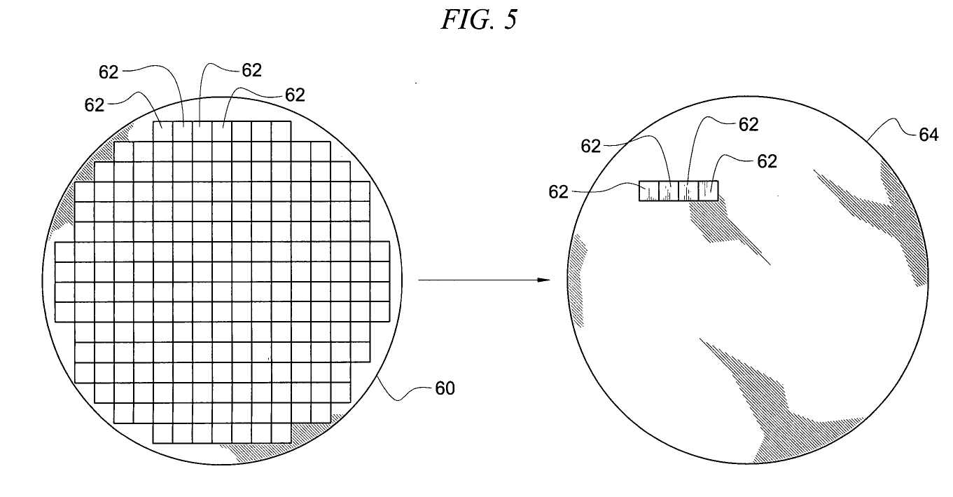

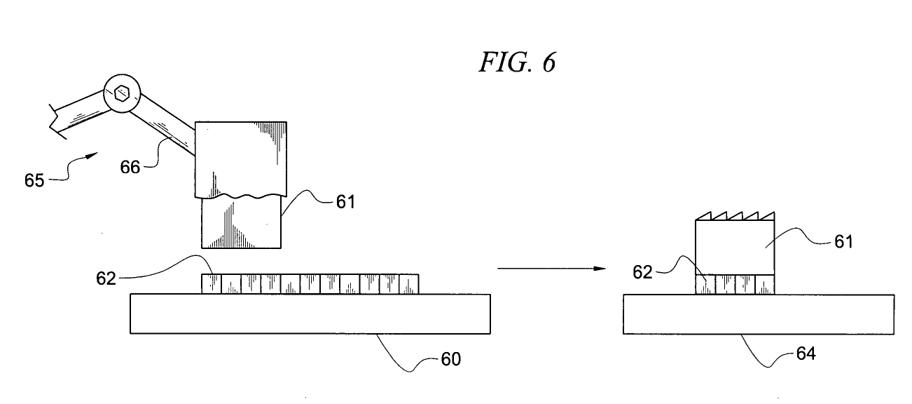

Referring to FIGS. 5 and 6, the operation of an example collet is set forth in detail. In these example embodiments, the present invention is being utilized to place a series of light-emitting diodes, created from a single wafer 60 by cutting or dicing the wafer using a saw, laser, or other cutting means (not shown). In the depicted embodiments, wafer 60 becomes the source location for the chips. Arm 66 of pick-and-place machine 65 can then be manipulated so that collet 61, arranged according to one embodiment of the present invention, is placed just above a series of chips 62. A vacuum is then applied to collet 61 such that chips 62 are lifted and held in place against collet 61. While the vacuum is maintained, arm 66 of the pick-and-place machine 65 is then moved until chips 62 are in the desired position on substrate 64 or other desired location. Once chips 62 are in position, the vacuum can then be released, disengaging chips 62 from collet 61. The process can then be repeated until the desired number of chips are in place.

While the present invention has been described in terms of positioning semiconductor chips such as light-emitting diodes, it will be appreciated that a system arranged according to the invention may be used to place any similar item whose placement and spacing needs to be maintained such as semiconductors, memory chips, or even non-electronic components.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skills in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A collet comprising:
a collet body;
at least two orifices in a face of said collet body arranged to provide appropriate spacing for target components; and
a central channel pneumatically connected to said orifices, wherein a vacuum applied to said central channel provides a lifting force to said target components.

2. The collet of claim 1 wherein said central channel is pneumatically connected to said orifices by means of intermediate channels.

3. The collet of claim 1 wherein said orifices are arranged in a linear pattern.

4. The collet of claim 1 wherein said orifices are arranged in a two dimensional pattern.

5. The collet of claim 1 wherein said orifices have tapered edges.

6. The collet of claim 1 wherein said orifices have edges flush with said face of said collet.

7. A system for the placement of electronic components comprising:
a collet having two or more orifices in a face;
an arm attached to said collet capable of positioning said face in at least a starting position and an ending position; and
a channel arrangement passing pneumatic pressure to said orifices.

8. The system of claim 7 wherein said channel arrangement comprises a central channel pneumatically connected to said orifices.

9. The system of claim 8 wherein the central channel is pneumatically connected to the orifices by means of intermediate channels.

10. The system of claim 7 wherein said orifices are described in part by tapered edges.

11. The system of claim 7 wherein said orifices are arranged in a linear pattern

12. The system of claim 7 wherein said orifices are arranged in a two dimensional pattern.

13. The system of claim 7 wherein said orifices have flat edges.

14. The system of claim 7 wherein said electronic components are light emitting diodes.

15. A method for moving components while maintaining component arrangement, comprising:
providing a lifting force at a face of a single collet connected to a pick-and-place apparatus capable of lifting at least two components simultaneously;
addressing at least two components with said collet simultaneously;
lifting said at least two components from a first location simultaneously; and
placing said components at a second location simultaneously; wherein said lifting and placing does not substantially alter the arrangement said components had when addressed.

16. The method of claim 15 wherein said components are electronic components

17. The method of claim 16 wherein said components are light-emitting diodes.

18. The method of claim 15 wherein said lifting force is pneumatic pressure transferred through said collet to at least two orifices arranged in a face of said collet.

19. The method of claim 18 wherein said arrangement is a separation between said at least two components.

21. The method of claim 18 wherein said arrangement is a two-dimensional pattern.
